(19) United States
(12) Patent Application Publication
(10) Pub. No.: US 2024/0249155 A1
(43) Pub. Date: Jul. 25, 2024

(54) DERIVING A COMPOUND METRIC USING MACHINE LEARNING MODEL PREDICTION OF USER BEHAVIOR AT A REMOTE LOCATION

(71) Applicant: Capital One Services, LLC, McLean, VA (US)

(72) Inventors: Samuel YIP, East Brunswick, NJ (US); Tyler MAIMAN, Melville, NY (US); Joshua EDWARDS, Philadelphia, PA (US); Bryant YEE, Silver Spring, MD (US); Haytham YAGHI, Oakton, VA (US)

(21) Appl. No.: 18/156,645

(22) Filed: Jan. 19, 2023

(51) Int. Cl. G06N 5/022

(52) U.S. Cl. CPC G06N 5/022

(57) ABSTRACT

In some implementations, a device may determine, using a machine learning model and based on interaction data relating to interactions between a plurality of entities and a user, a machine learning prediction of a behavior of the user at a location. The device may determine a distance and a transportation mode for each of one or more predicted locations associated with the behavior of the user and a lodging unit of the location. The distance and the transportation mode may indicate a transportation amount. The device may transmit, to a user device of the user, information indicating a total amount associated with the lodging unit. The total amount includes a lodging amount associated with the lodging unit and transportation amounts for the one or more predicted locations.

### BACKGROUND

Artificial intelligence describes different ways that a machine interacts with an environment. Through advanced, human-like intelligence (e.g., provided by software and hardware), an artificial intelligence system may perceive an environment and take actions that maximize a chance of achieving goals. Machine learning is an approach, or a subset, of artificial intelligence, with an emphasis on learning rather than just computer programming. A machine learning system may utilize complex models to analyze a massive amount of data, recognize patterns among the data, and generate an output (e.g., a prediction, a classification, or the like) without requiring a human to program specific instructions.

### SUMMARY

Some implementations described herein relate to a system for machine learning model prediction of user behavior at a remote location. The system may include one or more memories and one or more processors communicatively coupled to the one or more memories. The one or more processors may be configured to receive, from a user device of a user, an indication of a remote location. The one or more processors may be configured to retrieve interaction data relating to interactions between a plurality of entities and the user. The one or more processors may be configured to determine, using a machine learning model and based on the interaction data, a machine learning prediction indicating one or more predicted locations of the user at the remote location. The one or more processors may be configured to determine, for each predicted location of the one or more predicted locations of the machine learning prediction, a distance and a transportation mode between that predicted location and a lodging unit of the remote location, where the distance and the transportation mode indicate a transportation amount associated with that predicted location. The one or more processors may be configured to determine a compound metric indicating a total amount associated with the lodging unit, where the total amount includes a lodging amount associated with the lodging unit and transportation amounts for the one or more predicted locations. The one or more processors may be configured to transmit, to a device associated with the lodging unit and based on the total amount satisfying a condition, an indication to secure the lodging unit for the user.

Some implementations described herein relate to a method of machine learning model prediction of user behavior at a remote location. The method may include receiving, by a device from a user device of a user, an indication of a remote location. The method may include retrieving, by the device, interaction data relating to interactions between a plurality of entities and the user. The method may include determining, by the device using a machine learning model and based on the interaction data, a machine learning prediction of a behavior of the user at the remote location. The method may include determining, by the device, a distance and a transportation mode for each of one or more predicted locations associated with the behavior of the user and a lodging unit of the remote location, where the distance and the transportation mode indicate a transportation amount. The method may include determining, by the device, a total amount associated with the lodging unit, where the total amount includes a lodging amount associated with the lodging unit and transportation amounts for the one or more predicted locations. The method may include transmitting, by the device to the user device, information indicating the total amount associated with the lodging unit.

Some implementations described herein relate to a non-transitory computer-readable medium that stores a set of instructions for machine learning model prediction of user behavior at a remote location for a device. The set of instructions, when executed by one or more processors of the device, may cause the device to determine, using a machine learning model and based on interaction data relating to interactions between a plurality of entities and a user, a machine learning prediction of a behavior of the user at a location. The set of instructions, when executed by one or more processors of the device, may cause the device to determine a distance and a transportation mode for each of one or more predicted locations associated with the behavior of the user and a lodging unit of the location, where the distance and the transportation mode indicate a transportation amount. The set of instructions, when executed by one or more processors of the device, may cause the device to transmit, to a user device of the user, information indicating a total amount associated with the lodging unit, where the total amount includes a lodging amount associated with the lodging unit and transportation amounts for the one or more predicted locations.

### BRIEF DESCRIPTION OF THE DRAWINGS

FIGS. 1A-1E are diagrams of an example associated with deriving a compound metric using machine learning model prediction of user behavior at a remote location, in accordance with some embodiments of the present disclosure.

FIG. 2 is a diagram illustrating an example of training and using a machine learning model in connection with prediction of user behavior at a remote location, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with deriving a compound metric using machine learning model prediction of user behavior at a remote location, in accordance with some embodiments of the present disclosure.

FIG. 5 is a flowchart of an example process associated with deriving a compound metric using machine learning model prediction of user behavior at a remote location, in accordance with some embodiments of the present disclosure.

### DETAILED DESCRIPTION

The following detailed description of example implementations refers to the accompanying drawings. The same reference numbers in different drawings may identify the same or similar elements.

Vast amounts of data may be stored electronically in databases. A device may perform multiple queries to unrelated databases to obtain data relevant to a user. For example, a travel recommendation system may obtain data relating to lodging rates (e.g., hotel rates) for a location, data relating to attractions at the location, data relating to transportation options for the location, data relating to transportation rates for the location, or the like, by performing numerous queries to multiple unrelated databases.

Because each database may employ a particular schema and/or use particular data formatting conventions for data storage, the data may be difficult to integrate into compound metrics (e.g., a compound metric may convey several items of data in a more compact format relative to each item of data individually). As a result, the data may be individually presented to the user in a user interface (e.g., a web page). Here, the device may separately process and/or reformat data from different databases to obtain usable information for display to a user, thereby expending significant computing resources (e.g., processor resources and/or memory resources). Moreover, the individual presentation of data from different databases (e.g., rather than using compound metrics) may increase the size of a user interface (e.g., a web page) or utilize multiple user interfaces (e.g., multiple web pages). Navigating through a large user interface or a large number of user interfaces to find relevant information creates a poor user experience, consumes excessive computing resources that are needed for a client device to generate and display the user interface(s) and that are needed for one or more server devices to serve the user interface(s) to the client device, and consumes excessive network resources that are needed for communications between the client device and the server device.

Some implementations described herein enable integration of data from multiple unrelated databases into compound metrics for presentation to a user. In some implementations, a system may use a machine learning model to predict a behavior of the user at a remote location (e.g., a location other than a residence location of the user) based on interaction data relating to interactions (e.g., transactions) between a plurality of entities and the user. The predicted behavior of the user may indicate locations that the user is predicted to visit at the remote location. Based on the predicted behavior of the user and data relating to lodging rates (e.g., hotel rates) for the remote location, data relating to attractions at the remote location, data relating to transportation options for the remote location, and/or data relating to transportation rates for the remote location obtained by querying multiple unrelated databases, the system may generate a compound metric indicating a total amount associated with a lodging unit of the remote location (e.g., the total amount indicating a lodging amount for the lodging unit and transportation amounts for travel between the lodging unit and the predicted locations).

In some implementations, the system may provide the compound metric for presentation on a user device of the user, and the compound metric may convey data from the multiple unrelated databases in a compact format. In this way, the system conserves computing resources that otherwise may have been used to separately process and/or reformat data from different databases to obtain usable information for display to the user. Moreover, use of the compound metric to convey data from the multiple unrelated databases may decrease a size of a user interface or decrease a number of user interfaces that otherwise would have been used to individually present data from the multiple unrelated databases. In this way, the user experience is improved, and the use of computing resources and network resources is reduced in connection with serving, generating, and/or displaying the user interface(s).

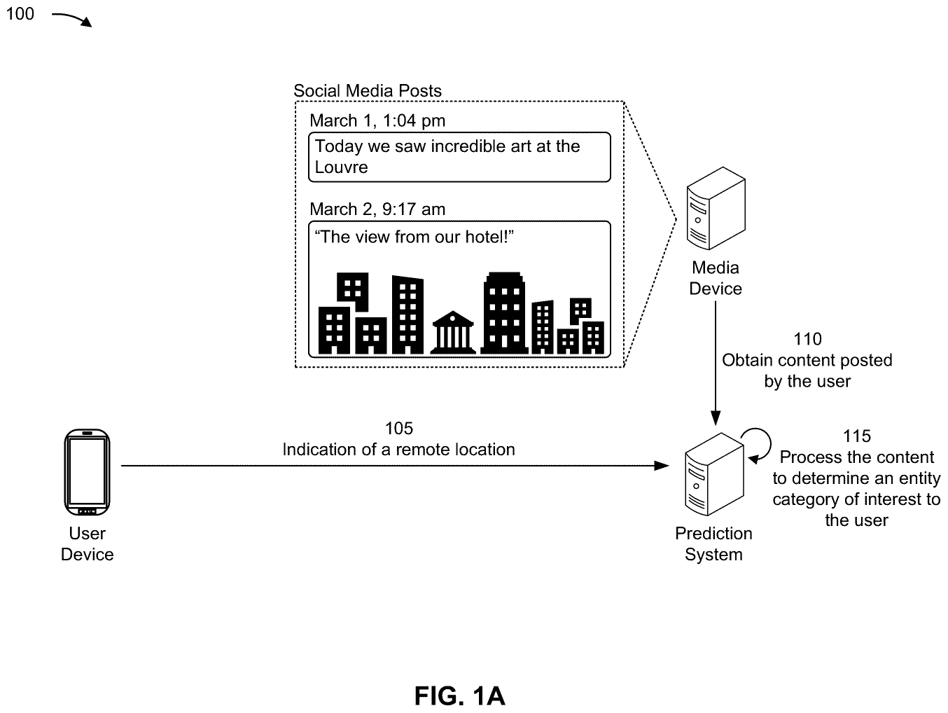

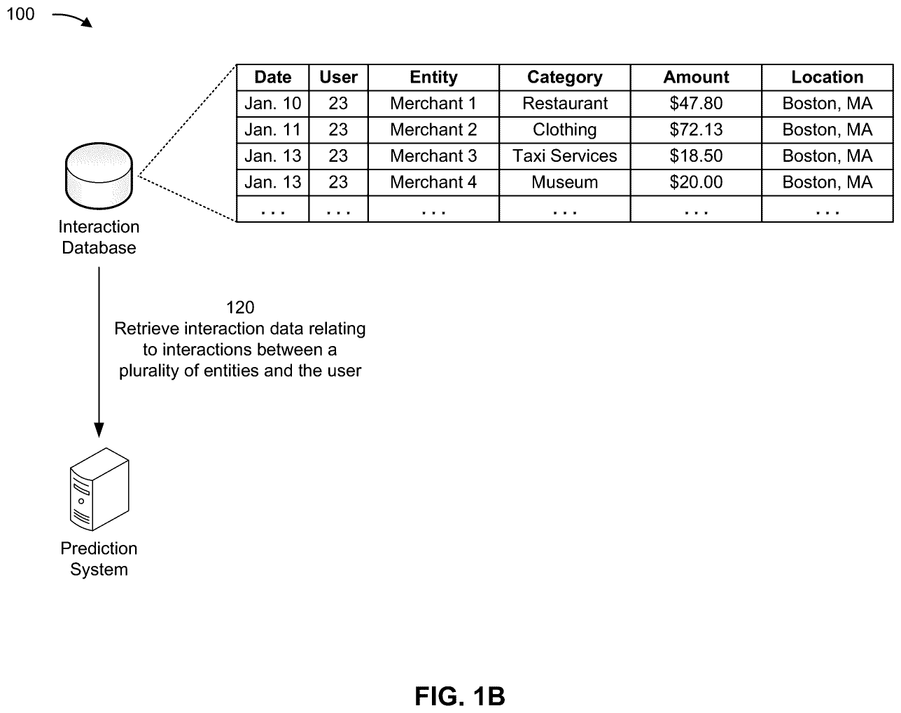

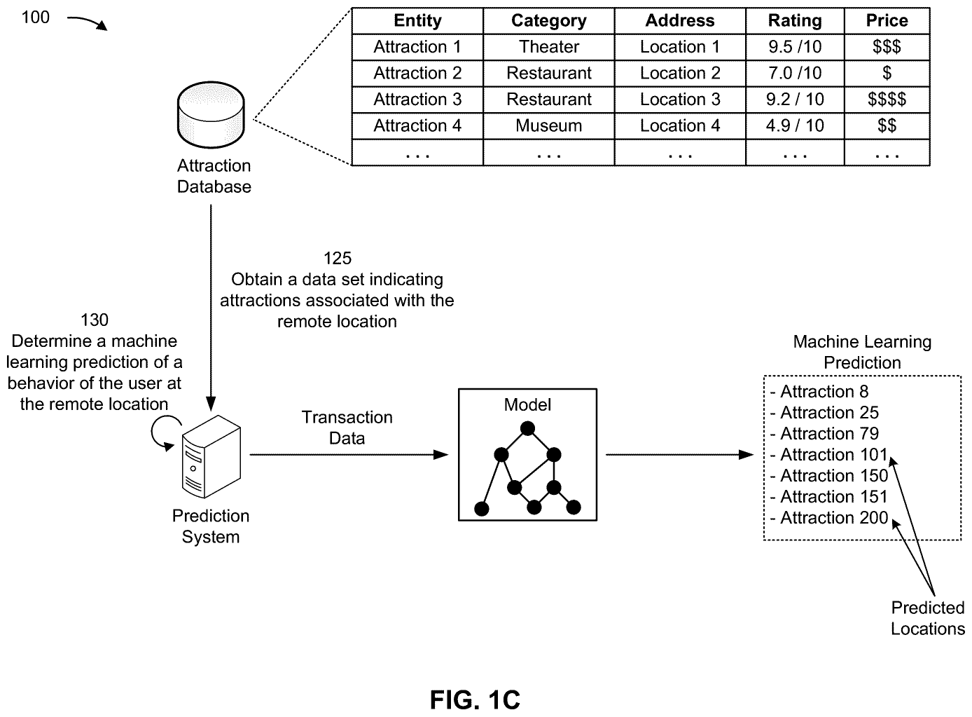

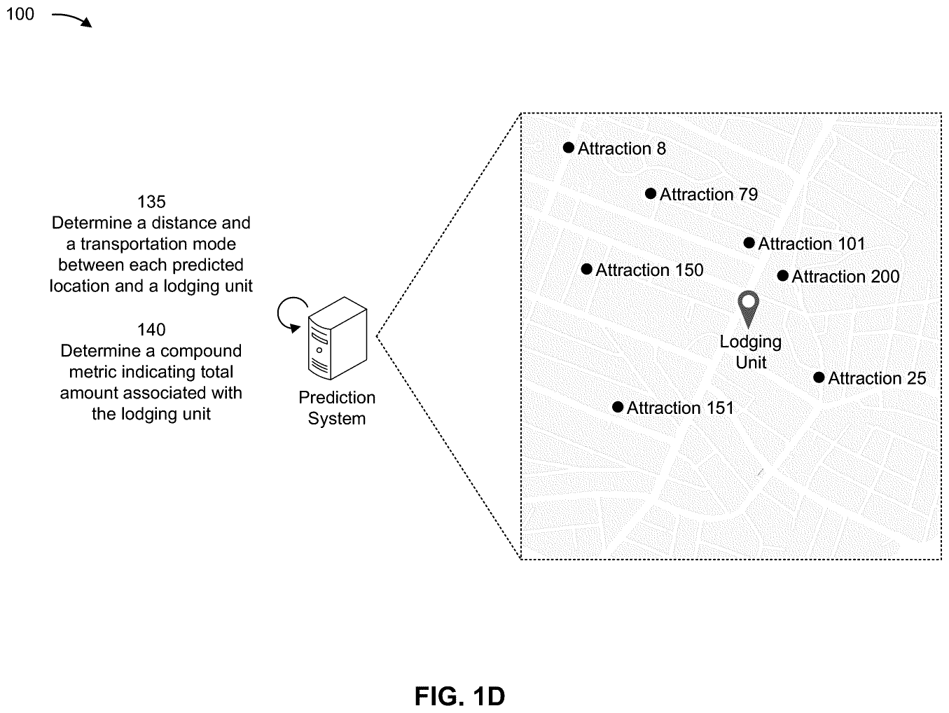

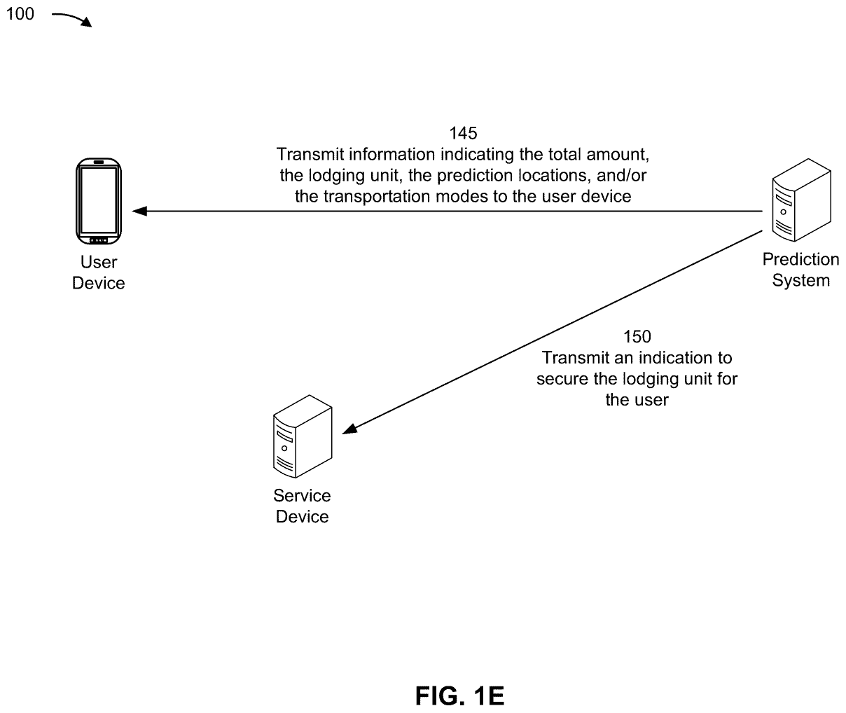

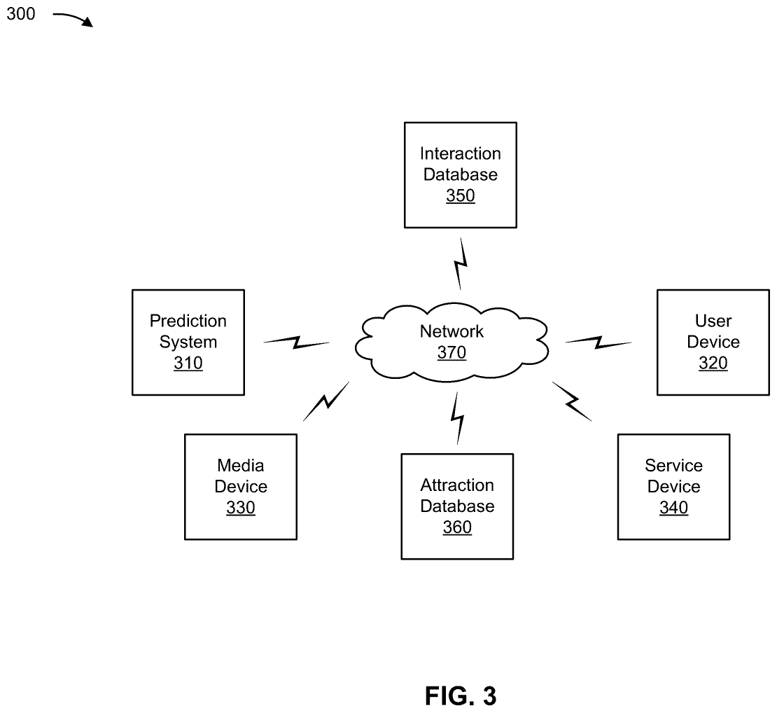

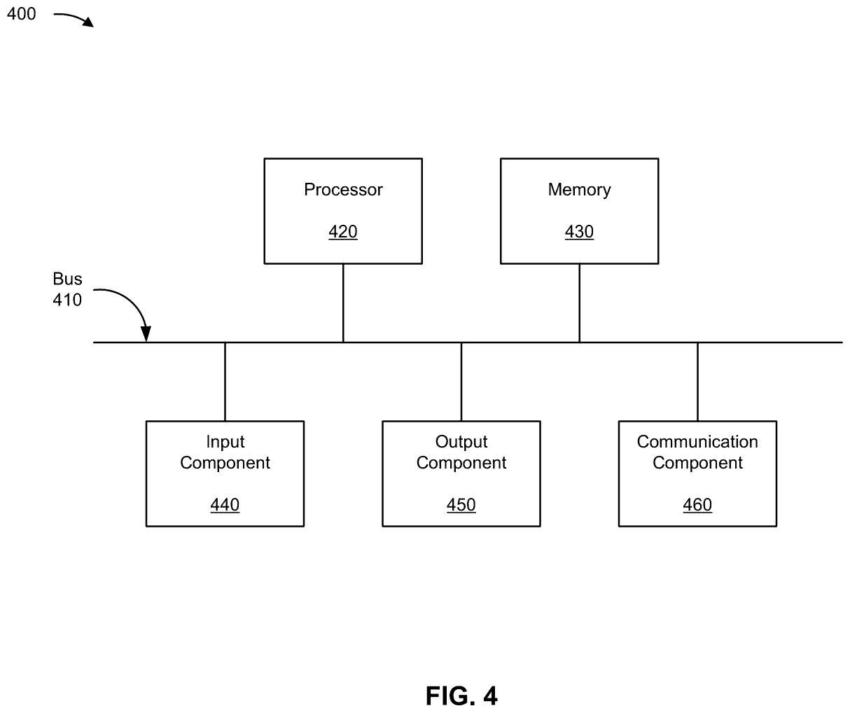

FIGS. 1A-1E are diagrams of an example 100 associated with deriving a compound metric using machine learning model prediction of user behavior at a remote location. As shown in FIGS. 1A-1E, example 100 includes a prediction system, a user device, a media device, a service device, and one or more databases (e.g., an interaction database, an attraction database, or the like). These devices are described in more detail in connection with FIGS. 3 and 4. The prediction system may be associated with an entity, such as a financial institution, that provides travel recommendations (e.g., flight recommendations, hotel recommendations, or the like) and/or travel booking. In some implementations, the prediction system may generate a user interface, for presentation on the user device, that facilitates inputting of travel parameters (e.g., a travel destination, dates of travel, quantity of travelers, or the like), viewing of travel recommendations, and/or booking of travel items (e.g., hotels, flights, car rentals, or the like). The user device may be associated with a user. In some implementations, the user may have an account (e.g., a transaction account, such as a credit account) with the entity associated with the prediction system. Accordingly, the prediction system may have access to information associated with the user, such as a name of the user, an email for the user, and/or a residence location of the user (e.g., a city, a zip code, a county, or the like, in which the user resides), among other examples.

As shown in FIG. 1A, and by reference number 105, the prediction system may receive, from the user device, an indication of a remote location (e.g., a geographic location other than the residence location of the user). For example, the remote location may be a destination to which the user is to travel. In some implementations, the prediction system may receive, from the user device, a set of constraints associated with the user. For example, the set of constraints may indicate travel preferences of the user (e.g., general travel preferences and/or travel preferences particular to the remote location, such as whether the user prefers rental cars, whether the user prefer home rentals, whether the user prefers staying in a business district, a maximum walking distance for the user, a maximum driving distance for the user, a maximum distance between lodging and attractions, or the like), travel parameters for the user's travel to the remote location (e.g., a date of departure, a date of return, a quantity of travelers, a relationship of the user and other travelers, a purpose of the travel, or the like), and/or activity preferences of the user (e.g., general activity preferences and/or activity preferences particular to the remote location, such as whether the user prefers sightseeing, whether the user prefers 5-star restaurants, or the like), among other examples.

As shown by reference number 110, the prediction system may obtain content posted by the user. For example, the content may be posted by the user to a social media account of the user (e.g., which the prediction system may identify based on the name of the user, the email for the user, or the like). Accordingly, the prediction system may obtain the content from the media device, which may serve media posted by users to social media accounts. The content may include one or more images, one or more videos, text, or the like. The content obtained by the prediction system may be associated with data or metadata indicating a location that is different from the residence location of the user. For example, text posted by the user may include data indicating a location (e.g., “I love visiting Paris.”) As another example, metadata for an image may indicate an image location (e.g., a geographical location at which a device that captured the image was located when the image was captured). The prediction system may scan content posted by the user to identify content associated with data or metadata indicating a location that is different from the residence location of the user (e.g., while discarding content associated with data or metadata indicating an image location that corresponds to the residence location of the user).

The content obtained by the prediction system may indicate a location. For example, text may include a description of the user's experience at a location (e.g., “Today we saw incredible art at the Louvre.”). As another example, an image or a video may depict the user at a location, such as depicting the user eating a meal at a restaurant or riding in a taxi, or the image or the video may depict a feature (e.g., a building, a monument, a natural feature, or the like) of a location, such as depicting a building, a waterfall, or a beach. As shown by reference number 115, the prediction system may process the content to determine an entity category of interest to the user that is associated with the location indicated by the content.

In some implementations, the prediction system may perform natural language processing (NLP) on text to determine a location indicated in the text and an entity category associated with the text. For example, if the text is, “Today we saw incredible art at the Louvre,” the prediction system may perform NLP on the text to determine that the location is “Louvre” and that an entity category associated with the location is “museum.” In some implementations, the prediction system may perform image recognition on an image or a video to determine an entity category associated with a location depicted in the image or the video. For example, if the image or the video depicts the user eating a meal at a restaurant, the entity category determined by the prediction system may be “restaurant.” As another example, if the image or the video depicts a waterfall, the entity category determined by the prediction system may be “wildlife area.” In this way, the prediction system may use content posted by the user to determine travel preferences of the user and/or activity preferences of the user when the user is traveling.

As shown in FIG. 1B, and by reference number 120, the prediction system may retrieve interaction data relating to interactions between a plurality of entities and the user. The prediction system may obtain the interaction data from the interaction database. As shown, the interaction database may store historical interaction data (e.g., historical transaction data, or the like). The historical interaction data may include one or more entries respectively associated with one or more interactions. An interaction may include a transaction or other exchange for goods and/or services between a user and an entity (e.g., a merchant). As shown, an entry of the historical interaction data may include data associated with an interaction. For example, the entry may identify a date and/or a time of the interaction, a user associated with the interaction, an entity associated with the interaction, a category associated with the entity, an amount of the interaction, and/or a location of the entity, among other examples. In some implementations, the prediction system may filter the interaction data, or retrieve filtered interaction data, to include only entries for interactions associated with locations other than the residence location of the user. In this way, the interaction data may be more relevant to a travel scenario.

As shown in FIG. 1C, and by reference number 125, the prediction system may obtain, from the attraction database, a data set indicating attractions (e.g., by name, address, entity category, rating, and/or price range, among other examples) associated with the remote location. For example, the data set may indicate restaurants, bars, museums, theaters, shops, wildlife areas, and/or parks, among other examples, associated with the remote location. The attraction database may be maintained by the entity associated with the prediction system or another entity.

As shown by reference number 130, the prediction system may determine, using a machine learning model, a machine learning prediction of a behavior of the user at the remote location. For example, the machine learning prediction may indicate one or more predicted locations of the user at the remote location (e.g., the behavior of the user may include travel within the remote location, and thus, the behavior of the user may be associated with the predicted locations). The predicted locations may be locations that the user is predicted to visit while at the remote location. Additionally, the machine learning prediction may indicate predicted amounts that the user is to spend at each of the predicted locations (e.g., the behavior of the user may include performing transactions at one or more of the predicted locations). For example, a predicted amount for a predicted location may be based on an entity category associated with the predicted location, a historical amount spent at the predicted location (e.g., an average amount spent by other users), and/or a historical amount spent at the entity category (e.g., an average amount spent by the user or other users). In some implementations, the machine learning model may be trained, using a supervised learning technique and based on interaction data for a plurality of users, to output the machine learning prediction. Alternatively, the machine learning model may be trained, using an unsupervised learning technique, to perform clustering of the user with other similar users, and the predicted locations of the machine learning prediction may be locations associated with interactions of the other users clustered with the user.

In some implementations, the prediction system may determine the machine learning prediction based on the interaction data (e.g., the filtered interaction data). For example, the prediction system may provide the interaction data as an input to the machine learning model. Additionally, or alternatively, the prediction system may determine the machine learning prediction based on the remote location, the data set indicating attractions associated with the remote location, and/or one or more characteristics associated with the user, among other examples. For example, the prediction system may provide information indicating the remote location, the data set, and/or the characteristics as an input to the machine learning model (e.g., along with the interaction data). As an example, the machine learning model may be trained to determine, based on the interaction data and the data set (e.g., as input to the machine learning model), a predicted level of interest that the user has in each attraction of the data set, and the predicted locations may include the locations for the attractions that are associated with the highest predicted levels of interest. Additionally, or alternatively, the prediction system may determine the machine learning prediction based on one or more entity categories of interest to the user that are determined based on content posted by the user, as described above. For example, the prediction system may provide the one or more entity categories of interest to the user as an input to the machine learning model.

In some implementations, the machine learning prediction may be in accordance with the set of constraints (e.g., the predicted locations indicated by the machine learning prediction may adhere to activity preferences of the set of constraints). For example, the set of constraints may be an input to the machine learning model. As another example, the prediction system may modify the machine learning prediction in accordance with the set of constraints. In some implementations, the prediction system may generate an embedding representative of the interaction data, and the prediction system may provide the embedding as an input to the machine learning model.

In some implementations, the machine learning prediction may be based on entity categories, distances from the residence location of the user, and/or amounts associated with interactions of the interaction data. For example, if the interaction data of the user indicates that the user frequently performs interactions at restaurants within one mile of the residence location of the user for an amount less than $50 on average, then a predicted location of the machine learning prediction may be associated with a nearby affordable restaurant. In some implementations, the machine learning prediction may indicate the predicted locations as an itinerary for the user (e.g., the machine learning prediction may indicate times and/or dates that the user is predicted to visit each of the predicted locations). Here, the itinerary may be based on times associated with interactions of the interaction data and/or a sequence in which interactions of the interaction data occurred. For example, if the interaction data of the user indicates that the user tends to perform interactions at coffee shops around 7 am, then the itinerary may indicate that the user is predicted to visit a predicted location associated with a coffee shop at 7 am. In some implementations, the machine learning model may be trained to determine the machine learning prediction based on a feature set that includes an entity category associated with an interaction, a location associated with an interaction, an amount associated with an interaction, and/or a time associated with an interaction.

In some implementations, the machine learning prediction may include one or more entity identifiers (e.g., particularly identifying entities, such as “Joe's Pizza” or “The Natural History Museum”), and the predicted locations of the machine learning prediction may be associated with the one or more entity identifiers. For example, an entity identifier “456” maybe associated with “Joe's Pizza” that is associated with a location of “123 Main Street.” The entity identifiers of the machine learning prediction may be obtained from previous interactions of one or more other users (e.g., indicated by interaction data of the other users).

In some implementations, the machine learning prediction may include one or more entity categories (e.g., “restaurant,” “museum,” “theater,” or the like). Here, the predicted locations of the machine learning prediction may be associated with entities that fall within the entity categories. The machine learning prediction may indicate the predicted locations by indicating the entity categories. For example, the entity category “restaurant” may include “Joe's Pizza” that is associated with a location of “123 Main Street.” The machine learning prediction including entity categories (rather than entity identifiers) allows for the user's predicted itinerary to include entities that may not have been the subject of a previous transaction of another user.

In examples where the machine learning prediction indicates entity categories, the prediction system may use the data set, obtained from the attraction database, indicating attractions associated with the remote location. The prediction system may identify, from the data set, one or more entities associated with (e.g., that fall within) the entity categories of the machine learning prediction. Thus, the predicted locations of the machine learning prediction may be associated with the one or more entities.

As shown in FIG. 1D, and by reference number 135, the prediction system may determine a distance and a transportation mode (e.g., a ride sharing service, a rental car, a car service, a train, a bus, a bicycle, walking, or the like) between each predicted location and a lodging unit (e.g., a hotel, a motel, a rental house, a rental apartment, a hostel, or the like) of the remote location. The transportation mode may be in accordance with the set of constraints (e.g., the transportation mode may adhere to travel preferences of the set of constraints). In some implementations, the prediction system may determine a transportation mode preference of the user. For example, the prediction system may use a machine learning model (e.g., the same machine learning model described above, or a different machine learning model) to determine the transportation mode preference of the user. The machine learning model may be trained to determine the transportation mode preference based on the interaction data. For example, if the interaction data indicates that the user frequently performs interactions with entities associated with ride sharing services, then the machine learning model may determine that the transportation mode preference of the user is ride sharing services. Accordingly, the transportation mode may correspond to the transportation mode preference determined for the user.

The distance and the transportation mode may together indicate a transportation amount associated with the predicted location (e.g., a transportation cost for the user to travel from the lodging unit to the remote location, which may include a parking cost if the transportation mode is a rental car). In some implementations, the transportation amount may be based on a purpose of the travel of the user, a quantity of travelers with the user, or the like (e.g., as indicated by the set of constraints). For example, if the purpose of the travel is a ski trip, and the transportation mode is a rental car, then the transportation amount may reflect an amount associated with a larger rental car or a rental car with four-wheel drive. The prediction system may determine a set of transportation amounts for the lodging unit, where the set of transportation amounts indicates respective transportation amounts associated with each of the predicted locations. In some implementations, the prediction system may determine distances and transportation modes between each predicted location and a plurality of lodging units of the remote location, to thereby determine respective sets of transportation amounts for the plurality of lodging units.

In some implementations, the prediction system may obtain a list of lodging units of the remote location from one or more lodging databases. For example, the prediction system may transmit, to a device, a request (e.g., via an application programming interface (API)) for the list of lodging units, and the prediction system may receive, from the device, a response to the request (e.g., via the API) that indicates the list of lodging units. The list of lodging units may also indicate respective locations and respective lodging amounts (e.g., rates) for the lodging units (e.g., for the travel dates of the user as indicated by the set of constraints). In some implementations, the prediction system may determine distances between the lodging unit and the predicted locations by locally computing the distances (e.g., using a shortest path algorithm, or the like). Alternatively, the prediction system may determine the distances by transmitting, to a device that computes distances, a request (e.g., via an API) identifying the location of the lodging unit and the predicted locations, and receiving, from the device, a response to the request (e.g., via the API) that indicates the distances. In some implementations, the response may also indicate, for each predicted location, one or more available transportation modes and/or rates associated with the available transportation modes. Additionally, or alternatively, the prediction system may determine the available transportation modes for each predicted location (e.g., using map data stored by the prediction system or obtained from another device) and/or rates associated with the available transportation modes (e.g., using rate data stored by the prediction system or obtained from another device).

In some implementations, the prediction system may determine a prediction that the user is to travel to multiple predicted locations in sequence. For example, the prediction system may determine a prediction that the user is to travel to a first predicted location and a second predicted location, of the predicted locations, sequentially. The prediction system may determine the prediction based on map data. For example, the prediction system, using the map data, may determine distances between the predicted locations. Continuing with the example, the prediction system may determine the prediction that the user is to travel to the first predicted location and the second predicted location sequentially if a distance between the first predicted location and the second predicted location satisfies (e.g., is less than) a threshold (e.g., 0.5 miles). Accordingly, the transportation amounts determined by the prediction system may reflect the prediction that the user is to travel to the first location and the second location sequentially. For example, rather than the transportation amounts reflecting travel from the lodging unit to the first predicted location and from the lodging unit to the second predicted location, the transportation amounts may reflect travel from the lodging unit to the first predicted location and from the first predicted location to the second predicted location.

As shown by reference number 140, the prediction system may determine (e.g., compute) a compound metric indicating a total amount associated with the lodging unit. The total amount may include (e.g., may be a sum of) a lodging amount associated with the lodging unit (e.g., a cost of the lodging unit for a duration of the user's visit to the remote location) and the transportation amounts for the predicted locations (e.g., the compound metric conveys information relating to lodging and transportation in a compact format relative to conveying information relating to lodging and transportation individually). In some implementations, the total amount may further include predicted amounts (e.g., amounts that the user is predicted to spend) for the predicted locations. In some implementations, the prediction system may determine respective compound metrics indicating total amounts associated with the plurality of lodging units.

As shown in FIG. 1E, and by reference number 145, the prediction system may transmit information indicating the total amount (e.g., the total amounts for the plurality of lodging units), the lodging unit (e.g., the plurality of lodging units), the predicted locations, and/or the transportation modes to the user device. For example, the prediction system may transmit the information to cause the user device to present the information (or other information derived therefrom) in the user interface. In some implementations, the information may include code configuring one or more user interface elements for the user interface. For example, the code may configure a user interface element to automatically cause transmission of an indication to secure the lodging unit for the user responsive to a user interaction with the user interface element. As another example, the code may configure one or more user interface elements to enable the user to remove a predicted location from the predicted locations, to add a predicted location to the predicted locations, to indicate a transportation preference for a predicted location, or the like. In some implementations, the prediction system may select a lodging unit, from the plurality of lodging units, for recommendation to the user, and the information transmitted to the user device may indicate the selected lodging unit. In some implementations, the selected lodging unit may best optimize lowering total amount and satisfying travel preferences (e.g., lodging preferences) of the user (e.g., the selected lodging unit may be associated with a lowest total amount among lodging units that satisfy the most travel preferences of the user).

As shown by reference number 150, the prediction system may transmit, to the service device associated with the lodging unit (e.g., a device that implements a reservation service for the lodging unit), an indication to secure the lodging unit for the user (e.g., a reservation of the lodging unit for the user for the user's travel dates). The prediction system may transmit the indication based on the total amount, associated with the lodging unit, satisfying a condition. For example, the condition may be that the total amount associated with the lodging unit is a lowest total amount among total amounts for the plurality of lodging units. As another example, the condition may be that a total distance between the predicted locations and the lodging unit is a lowest total distance among total distances associated with the plurality of lodging units. As a further example, the condition may be that a total transportation amount associated with the lodging unit is a lowest total transportation amount among total transportation amounts associated with the plurality of lodging units.

In some implementations, the prediction system may transmit, to a device associated with the transportation mode (e.g., a device that implements a reservation service for the transportation mode), an indication to secure the transportation mode for the user. For example, the indication to secure the transportation mode may be a reservation of the transportation mode (e.g., a ride sharing service, a rental car, a car service, or the like) for the user for the user's travel dates or a portion thereof. As another example, the indication to secure the transportation mode (e.g., a train, a bus, or the like) may be a request for a ticket for the user. In some implementations, the prediction system may transmit, to a device associated with one or more of the predicted locations (e.g., a device associated with a restaurant, a theater, a museum, or the like), an indication to secure a time slot for the user (e.g., a reservation time at a restaurant) and/or an indication to secure tickets for the user (e.g., tickets for a theater or for a museum). In some implementations, the information including code configuring one or more user interface elements for the user interface may include code configuring a user interface element to automatically cause transmission of an indication to secure the transportation mode for the user, secure a time slot for the user, and/or secure tickets for the user responsive to a user interaction with the user interface element. In some implementations, the prediction system may transmit a confirmation (e.g., indicating a confirmation number) of securing the lodging, securing the transportation mode, and/or securing the time slot, and/or transmit a digital ticket, to the user device.

In some implementations, the prediction system may generate a map and/or a set of directions based on the predicted locations of the machine learning prediction. The map may show the remote location and may include indicators identifying the predicted locations in the remote location. The set of directions may indicate directions between the lodging unit and a predicted location and/or between a first predicted location and a second predicted location. The prediction system may transmit the map and/or the set of directions to the user device. In some implementations, the prediction system may provide a list of addresses associated with the predicted locations and/or the lodging unit to a navigation system associated with a vehicle to cause the navigation system to generate driving directions to the predicted location(s) and/or the lodging unit, and/or to cause the navigation system to autonomously navigate the vehicle to the predicted locations(s) and/or the lodging unit. In some implementations, the prediction system may transmit, to a device associated with the lodging unit, the itinerary of the machine learning prediction (e.g., to enable a concierge, or the like, to book or plan the accommodations needed for the itinerary).

In some implementations, the prediction system may receive, from the user device, location data associated with the user device at the remote location. The prediction system may determine one or more locations of the remote location that were actually visited by the user based on the location data. In some implementations, the prediction system may transmit, to the user device, a request for the user to provide an indication of one or more locations of the remote location that were actually visited by the user, and the prediction system may receive, from the user device, the indication of the one or more locations. The prediction system, or another device, may use information relating to the actually-visited locations to retrain or otherwise update the machine learning model.

In this way, the prediction system conserves computing resources that otherwise may have been used to separately process and/or reformat data from different databases to obtain usable information for display to the user. Moreover, use of the compound metric indicating the total amount to convey data from the multiple unrelated databases may decrease a size of a user interface or decrease a number of user interfaces that otherwise would have been used to individually present data from the multiple unrelated databases. In this way, the user experience is improved, and the use of computing resources and network resources is reduced in connection with serving, generating, and/or displaying the user interface(s).

As indicated above, FIGS. 1A-1E are provided as an example. Other examples may differ from what is described with regard to FIGS. 1A-1E.

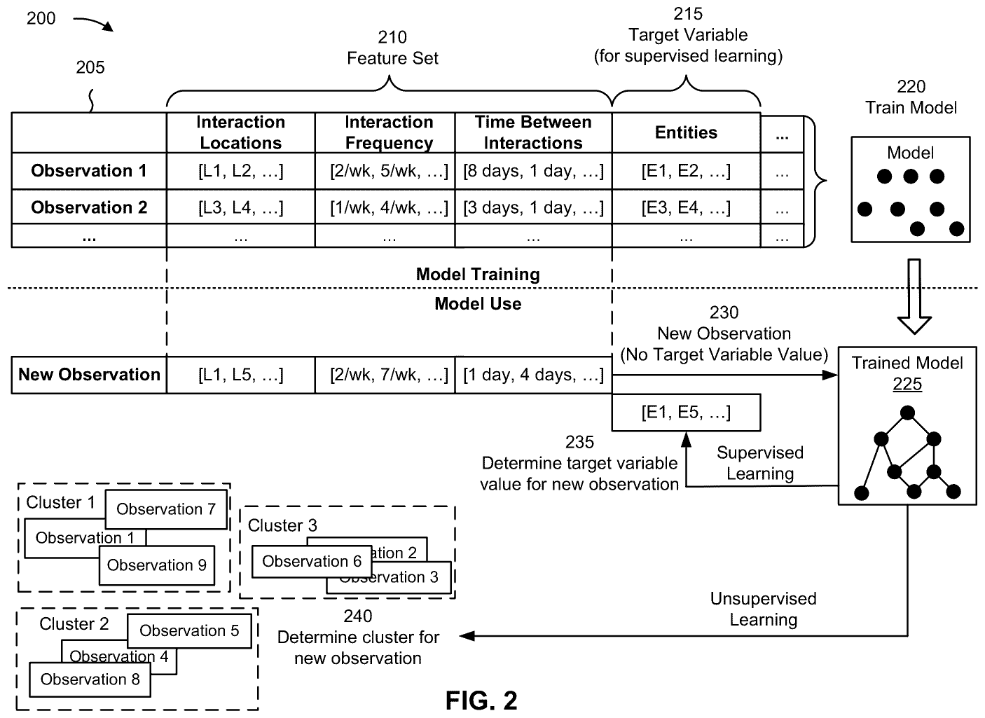

FIG. 2 is a diagram illustrating an example 200 of training and using a machine learning model in connection with prediction of user behavior at a remote location. The machine learning model training and usage described herein may be performed using a machine learning system. The machine learning system may include or may be included in a computing device, a server, a cloud computing environment, or the like, such as the prediction system and/or the storage system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the prediction system and/or the storage system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the prediction system and/or the storage system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of interaction locations, a second feature of interaction frequency, a third feature of time between interactions, and so on. As shown, for a first observation, the first feature may have a value of L1, L2, and so forth (where L1 and L2 represent locations of interactions), the second feature may have a value of 2 per week, 5 per week, and so forth (where 2 per week indicates the frequency of interactions in a first entity category and 5 per week indicates the frequency of interactions in a second entity category), the third feature may have a value of 8 days, 1 day, and so forth (where 8 days indicates an amount of time (e.g., an average time) between interactions in the first entity category and 1 day indicates the amount of time between interactions in the second entity category), and so on. These features and feature values are provided as examples, and may differ in other examples. For example, the feature set may include one or more of the following features: entity categories for interactions, locations of interactions, amounts of interactions, times of interactions, distances of interactions from a residence location, frequency of interactions in a particular entity category (e.g., over a particular time period), frequency of interactions with a particular entity (e.g., over a particular time period), time between interactions in a particular entity category, time between interactions with a particular entity, average amount of interactions in a particular entity category (e.g., over a particular time period), and/or average amount of interactions with a particular entity (e.g., over a particular time period), among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is entities, which has a value of E1, E2, and so forth for the first observation (where E1 and E2 represent entities that the user subsequently interacted with at a remote location (e.g., with respect to the training data)).

The feature set and target variable described above are provided as examples, and other examples may differ from what is described above. For example, for a target variable of preferred transportation mode, the feature set may include locations of interactions relating to transportation modes, amounts of interactions relating to transportation modes, times of interactions relating to transportation modes, frequency of interactions for a particular transportation mode (e.g., over a particular time period), time between interactions for a particular transportation mode, and/or average amount of interactions for a particular transportation mode (e.g., over a particular time period), among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, using a neural network algorithm, the machine learning system may train a machine learning model to output (e.g., at an output layer) a prediction of entities that a user is to visit at a remote location based on an input (e.g., at an input layer) indicating historical interactions of the user, as described elsewhere herein. In particular, the machine learning system, using the neural network algorithm, may train the machine learning model, using the set of observations from the training data, to derive weights for one or more nodes in the input layer, in the output layer, and/or in one or more hidden layers (e.g., between the input layer and the output layer). Nodes in the input layer may represent features of a feature set of the machine learning model, such as a first node representing interaction locations, a second node representing interaction frequency, a third node representing time between interactions, and so forth. One or more nodes in the output layer may represent output(s) of the machine learning model, such as a node indicating the entities that the user is to visit at the remote locations. The weights learned by the machine learning model facilitate transformation of the input of the machine learning model to the output of the machine learning model. After training, the machine learning system may store the machine learning model as a trained machine learning model 225 to be used to analyze new observations.

As an example, the machine learning system may obtain training data for the set of observations based on historical interaction data associated with one or more users. For example, the machine learning system may obtain the historical interaction data from the interaction database, as described elsewhere herein. The historical interaction data may indicate, for a historical interaction, an entity, an entity category, a user, an amount, a location, a date, and/or a time, among other examples. The historical interaction data may indicate entities and/or entity categories with which users performed interactions (e.g., at remote locations) subsequent to a previous set of entities and/or entity categories with which users performed interactions.

As shown by reference number 230, the machine learning system may apply the trained machine learning model 225 to a new observation, such as by receiving a new observation and inputting the new observation to the trained machine learning model 225. As shown, the new observation may include a first feature of interaction locations, a second feature of interaction frequency, a third feature of time between interactions, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of E1, E5, and so forth (where E1 and E5 represent entities that a user is predicted to visit at a remote location) for the target variable of entities for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation of a particular lodging unit. The first automated action may include, for example, transmitting an indication to secure a particular lodging unit for the user.

As another example, if the machine learning system were to predict a value of E2, E4, and so forth (where E2 and E4 represent entities that the user is predicted to visit at the remote location) for the target variable of entities, then the machine learning system may provide a second (e.g., different) recommendation (e.g., a recommendation of a different lodging unit) and/or may perform or cause performance of a second (e.g., different) automated action (e.g., transmitting an indication to secure a different lodging unit for the user).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., associated with a first group of users), then the machine learning system may identify one or more first entities from interactions of the first cluster. As another example, if the machine learning system were to classify the new observation in a second cluster (e.g., associated with a second group of users), then the machine learning system may identify one or more second entities from interactions of the second cluster.

In some implementations, a recommendation and/or an automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include predicted entities output by the trained machine learning model 225 and/or subsequent interactions performed by one or more users.

In this way, the machine learning system may apply a rigorous and automated process to predict user behavior at a remote location. The machine learning system may enable recognition and/or identification of tens, hundreds, thousands, or millions of features and/or feature values for tens, hundreds, thousands, or millions of observations, thereby increasing accuracy and consistency and reducing delay associated with prediction of user behavior at a remote location relative to requiring computing resources to be allocated for tens, hundreds, or thousands of operators to manually predict user behavior at a remote location using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a prediction system 310, a user device 320, a media device 330, a service device 340, an interaction database 350, an attraction database 360, and/or a network 370. Devices of environment 300 may interconnect via wired connections, wireless connections, or a combination of wired and wireless connections.

The prediction system 310 may include one or more devices capable of receiving, generating, storing, processing, providing, and/or routing information associated with machine learning model prediction of user behavior at a remote location, as described elsewhere herein. The prediction system 310 may include a communication device and/or a computing device. For example, the prediction system 310 may include a server, such as an application server, a client server, a web server, a database server, a host server, a proxy server, a virtual server (e.g., executing on computing hardware), or a server in a cloud computing system. In some implementations, the prediction system 310 may include computing hardware used in a cloud computing environment.

The user device 320 may include one or more devices capable of receiving, generating, storing, processing, and/or providing information associated with machine learning model prediction of user behavior at a remote location, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The media device 330 may include one or more devices capable of receiving, generating, storing, processing, providing, and/or routing information associated with user-posted content, as described elsewhere herein. The media device 330 may include a communication device and/or a computing device. For example, the media device 330 may include a server, such as an application server, a client server, a web server, a database server, a host server, a proxy server, a virtual server (e.g., executing on computing hardware), or a server in a cloud computing system. In some implementations, the media device 330 may include computing hardware used in a cloud computing environment.

The service device 340 may include one or more devices capable of receiving, generating, storing, processing, providing, and/or routing information associated with facilitating securing of services, as described elsewhere herein. The service device 340 may include a communication device and/or a computing device. For example, the service device 340 may include a server, such as an application server, a client server, a web server, a database server, a host server, a proxy server, a virtual server (e.g., executing on computing hardware), or a server in a cloud computing system. In some implementations, the service device 340 may include computing hardware used in a cloud computing environment.

The interaction database 350 may include one or more devices capable of receiving, generating, storing, processing, and/or providing information associated with historical interaction data, as described elsewhere herein. The interaction database 350 may include a communication device and/or a computing device. For example, the interaction database 350 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the interaction database 350 may store historical interaction data, as described elsewhere herein.

The attraction database 360 may include one or more devices capable of receiving, generating, storing, processing, and/or providing information associated with attraction data, as described elsewhere herein. The attraction database 360 may include a communication device and/or a computing device. For example, the attraction database 360 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the attraction database 360 may store attraction data relating to one or more locations (e.g., cities, counties, states, countries, or the like), as described elsewhere herein.

The network 370 may include one or more wired and/or wireless networks. For example, the network 370 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 370 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with deriving a compound metric using machine learning model prediction of user behavior at a remote location. The device 400 may correspond to prediction system 310, user device 320, media device 330, service device 340, interaction database 350, and/or attraction database 360. In some implementations, prediction system 310, user device 320, media device 330, service device 340, interaction database 350, and/or attraction database 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

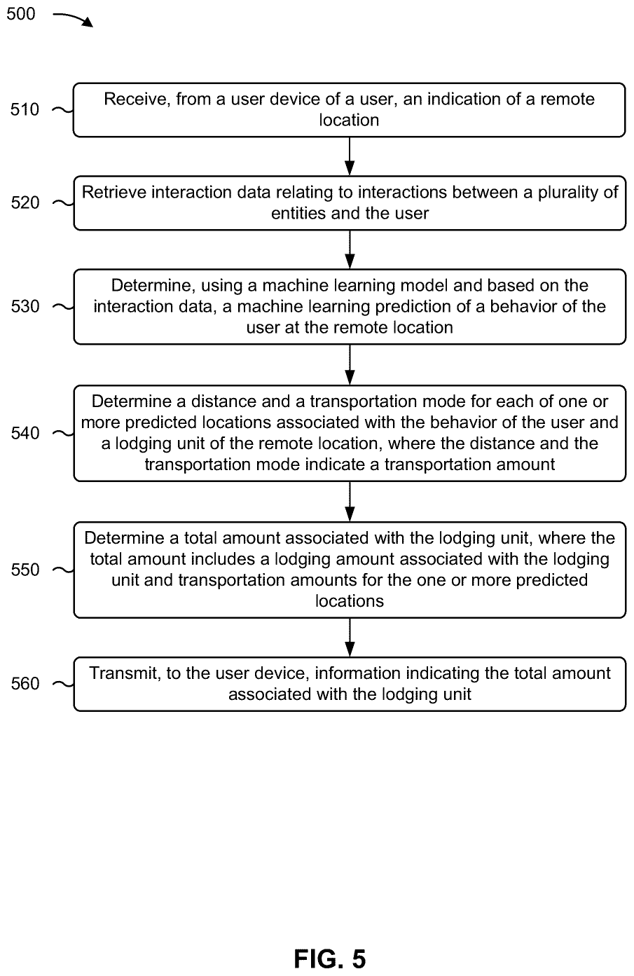

FIG. 5 is a flowchart of an example process 500 associated with deriving a compound metric using machine learning model prediction of user behavior at a remote location. In some implementations, one or more process blocks of FIG. 5 may be performed by the prediction system 310. In some implementations, one or more process blocks of FIG. 5 may be performed by another device or a group of devices separate from or including the prediction system 310, such as the user device 320, the media device 330, the service device 340, the interaction database 350, and/or the attraction database 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving an indication of a remote location (block 510). For example, the prediction system 310 (e.g., using processor 420, memory 430, input component 440, and/or communication component 460) may receive an indication of a remote location, as described above in connection with reference number 105 of FIG. 1A. As an example, the remote location may be a destination to which a user is to travel.

As further shown in FIG. 5, process 500 may include retrieving interaction data relating to interactions between a plurality of entities and the user (block 520). For example, the prediction system 310 (e.g., using processor 420, memory 430, input component 440, and/or communication component 460) may retrieve interaction data relating to interactions between a plurality of entities and the user, as described above in connection with reference number 120 of FIG. 1B. As an example, an interaction may include a transaction or other exchange for goods and/or services between a user and an entity (e.g., a merchant).

As further shown in FIG. 5, process 500 may include determining, based on the interaction data, a machine learning prediction of a behavior of the user at the remote location (block 530). For example, the prediction system 310 (e.g., using processor 420 and/or memory 430) may determine, based on the interaction data, a machine learning prediction of a behavior of the user at the remote location, as described above in connection with reference number 130 of FIG. 1C. As an example, the machine learning prediction may indicate one or more predicted locations of the user at the remote location, and the predicted locations may be locations that the user is predicted to visit while at the remote location.

As further shown in FIG. 5, process 500 may include determining a distance and a transportation mode for each of one or more predicted locations associated with the behavior of the user and a lodging unit of the remote location, where the distance and the transportation mode indicate a transportation amount (block 540). For example, the prediction system 310 (e.g., using processor 420 and/or memory 430) may determine a distance and a transportation mode for each of one or more predicted locations associated with the behavior of the user and a lodging unit of the remote location, where the distance and the transportation mode indicate a transportation amount, as described above in connection with reference number 135 of FIG. 1D. As an example, a transportation mode may include a ride sharing service, a rental car, a car service, a train, a bus, a bicycle, walking, or the like, and a lodging unit may include a hotel, a motel, a rental house, a rental apartment, a hostel, or the like.

As further shown in FIG. 5, process 500 may include determining a total amount associated with the lodging unit, where the total amount includes a lodging amount associated with the lodging unit and transportation amounts for the one or more predicted locations (block 550). For example, the prediction system 310 (e.g., using processor 420 and/or memory 430) may determine a total amount associated with the lodging unit, where the total amount includes a lodging amount associated with the lodging unit and transportation amounts for the one or more predicted locations, as described above in connection with reference number 140 of FIG. 1D. As an example, the total amount may be a compound metric that conveys information relating to lodging and transportation in a compact format relative to conveying information relating to lodging and transportation individually.

As further shown in FIG. 5, process 500 may include transmitting information indicating the total amount associated with the lodging unit (block 560). For example, the prediction system 310 (e.g., using processor 420, memory 430, output component 450, and/or communication component 460) may transmit information indicating the total amount associated with the lodging unit, as described above in connection with reference number 145 of FIG. 1E. As an example, the prediction system may transmit the information to cause a user device to present the information (or other information derived therefrom) in a user interface.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for machine learning model prediction of user behavior at a remote location, the system comprising:
one or more memories; and
one or more processors, communicatively coupled to the one or more memories, configured to:
receive, from a user device of a user, an indication of a remote location;
retrieve interaction data relating to interactions between a plurality of entities and the user;
determine, using a machine learning model and based on the interaction data, a machine learning prediction indicating one or more predicted locations of the user at the remote location;
determine, for each predicted location of the one or more predicted locations of the machine learning prediction, a distance and a transportation mode between that predicted location and a lodging unit of the remote location,
wherein the distance and the transportation mode indicate a transportation amount associated with that predicted location;
determine a compound metric indicating a total amount associated with the lodging unit,
wherein the total amount includes a lodging amount associated with the lodging unit and transportation amounts for the one or more predicted locations; and
transmit, to a device associated with the lodging unit and based on the total amount satisfying a condition, an indication to secure the lodging unit for the user.

2. The system of claim 1, wherein the condition is that the total amount is a lowest total amount among a plurality of total amounts for a plurality of lodging units.

3. The system of claim 1, wherein the one or more processors are further configured to:
receive, from the user device, a set of constraints associated with the user,
wherein the machine learning prediction and the transportation mode are in accordance with the set of constraints.

4. The system of claim 1, wherein the machine learning prediction includes one or more entity identifiers, and
wherein the one or more predicted locations are associated with the one or more entity identifiers.

5. The system of claim 1, wherein the machine learning prediction includes one or more entity categories.

6. The system of claim 5, wherein the one or more processors are further configured to:
identify, from a data set indicating attractions associated with the remote location, one or more entities associated with the one or more entity categories,
wherein the one or more predicted locations are associated with the one or more entities.

7. The system of claim 1, wherein the one or more processors are further configured to:
determine, based on map data, a prediction that the user is to travel to a first predicted location and a second predicted location, of the one or more predicted locations, sequentially,
wherein the transportation amounts for the one or more predicted locations reflects the prediction that the user is to travel to the first predicted location and the second predicted location sequentially.

8. The system of claim 1, wherein the one or more processors are further configured to:
determine, using an additional machine learning model and based on the interaction data, a transportation mode preference of the user,
wherein the transportation mode corresponds to the transportation mode preference.

9. A method of machine learning model prediction of user behavior at a remote location, comprising:
receiving, by a device from a user device of a user, an indication of a remote location;
retrieving, by the device, interaction data relating to interactions between a plurality of entities and the user;
determining, by the device using a machine learning model and based on the interaction data, a machine learning prediction of a behavior of the user at the remote location;
determining, by the device, a distance and a transportation mode for each of one or more predicted locations associated with the behavior of the user and a lodging unit of the remote location,
wherein the distance and the transportation mode indicate a transportation amount;
determining, by the device, a total amount associated with the lodging unit,
wherein the total amount includes a lodging amount associated with the lodging unit and transportation amounts for the one or more predicted locations; and
transmitting, by the device to the user device, information indicating the total amount associated with the lodging unit.

10. The method of claim 9, further comprising:
receiving, from the user device, a set of constraints associated with the user,
wherein the machine learning prediction and the transportation mode are in accordance with the set of constraints.

11. The method of claim 9, further comprising:
obtaining content posted by the user that is associated with data or metadata indicating a location that is different from a residence location of the user; and
processing the content to determine an entity category of interest to the user that is associated with the location,
wherein the machine learning prediction is determined further based on the entity category of interest to the user.

12. The method of claim 11, wherein the content is an image or a video, and
wherein processing the content comprises performing image recognition on the image or the video to determine the entity category associated with the location.

13. The method of claim 11, wherein the content is text, and
wherein processing the text comprises performing natural language processing on the text to determine the entity category associated with the location.

14. The method of claim 9, further comprising:
determining, using an additional machine learning model and based on the interaction data, a transportation mode preference of the user,
wherein the transportation mode corresponds to the transportation mode preference.

15. A non-transitory computer-readable medium storing a set of instructions for machine learning model prediction of user behavior at a remote location, the set of instructions comprising:
one or more instructions that, when executed by one or more processors of a device, cause the device to:
determine, using a machine learning model and based on interaction data relating to interactions between a plurality of entities and a user, a machine learning prediction of a behavior of the user at a location;
determine a distance and a transportation mode for each of one or more predicted locations associated with the behavior of the user and a lodging unit of the location,
wherein the distance and the transportation mode indicate a transportation amount; and
transmit, to a user device of the user, information indicating a total amount associated with the lodging unit,
wherein the total amount includes a lodging amount associated with the lodging unit and transportation amounts for the one or more predicted locations.

16. The non-transitory computer-readable medium of claim 15, wherein the one or more instructions, when executed by the one or more processors, further cause the device to:
transmit, to a device associated with the lodging unit, an indication to secure the lodging unit for the user.

17. The non-transitory computer-readable medium of claim 15, wherein the machine learning prediction of the behavior of the user indicates the one or more predicted locations as an itinerary.

18. The non-transitory computer-readable medium of claim 15, wherein the machine learning model is trained to determine the machine learning prediction based on a feature set that includes one or more of an entity category associated with an interaction, a location associated with an interaction, an amount associated with an interaction, or a time associated with an interaction.

19. The non-transitory computer-readable medium of claim 15, wherein the one or more instructions, when executed by the one or more processors, further cause the device to:
determine, using an additional machine learning model and based on the interaction data, a transportation mode preference of the user,
wherein the transportation mode corresponds to the transportation mode preference.

20. The non-transitory computer-readable medium of claim 15, wherein the one or more instructions, when executed by the one or more processors, further cause the device to: receive, from the user device of the user, an indication of the location and a set of constraints associated with the user.
